(19) United States
(12) Patent Application Publication
(10) Pub. No.: US 2021/0026943 A1
(43) Pub. Date: Jan. 28, 2021

(54) SYSTEM AND METHOD INCORPORATING GRAPHICAL AIDS FOR THE CREATION AND RETREIVAL OF ALPHANUMERIC PASSWORDS

(71) Applicant: Old Dominion University Research Foundation, Norfolk, VA (US)

(72) Inventors: Lauren Nicole Tiller, Chesapeake, VA (US); Catherine Angelini, Virginia Beach, VA (US); Sarah Leibner, Virginia Beach, VA (US); Jeremiah D. Still, Norfolk, VA (US)

(21) Appl. No.: 16/550,450

(22) Filed: Aug. 26, 2019

Related U.S. Application Data
(60) Provisional application No. 62/878,122, filed on Jul. 24, 2019.

(51) Int. Cl. G06F 21/36; H04L 9/32; G06F 21/62

(52) U.S. Cl. CPC G06F 21/36; G06F 2221/2131; G06F 21/62; H04L 9/3226

(57) ABSTRACT

The present invention relates to a system and method for authentication of user credentials utilizing a combination of both alphanumeric and graphical password generation and retrieval techniques which includes generating a map with a plurality of symbols populated on the map, wherein the symbols include a plurality of targets and distractors which are associated with alphanumeric characters and wherein a user can utilize the symbols on the map in a particular custom path on the map so as to aid in the generation and future recollection of a selected complex alphanumeric password.

### PRIORITY

The present application claims benefit to U.S. Provisional Application No. 62/878,122 which was filed on Jul. 24, 2019, which is hereby incorporated by reference in its entirety.

### FIELD OF THE INVENTION

The present disclosure generally relates to user authentication for purposes of terminal or system access.

### BACKGROUND OF THE INVENTION

The frequency and cost of cyber security attacks is increasing wherein system authentication has been identified as being a critical source of security failure within the infrastructure of a system. Authentication schemes typically verify a user's identity by requesting input from a user, which input can include a biometric input such as a fingerprint scan, presentation of an item, such as insertion of an encrypted USB key into a USB port, or use of an input device such as a mouse or a keyboard to select or input a password.

In an effort to increase account security, alphanumeric passwords typically need to meet an array of requirements, meaning they often need to have a large dimensional space; contain numbers and symbols; not contain mere dictionary words; be different for every account; and should be changed often.

Unfortunately, such passwords are often difficult to remember, wherein users often overcome cognitive difficulties by use of means which undermine security, for example by writing down passwords, using dictionary words, or by using personal dates/information.

### SUMMARY OF THE INVENTION

It has been recognized that a system which aids in the initial creation and later recollection of a complex and secure alphanumeric password would be beneficial in a wide variety of user authentication situations. As such contemplated herein is an authentication system and method, the system including: a terminal having a display interface; a user input interface; local processing circuitry; a local non-transitory computer-readable media; and a local communication module. The system can also include: a remote server having remote processing circuitry; remote non-transitory computer-readable media; and a remote communication module for receiving information from the terminal. In some embodiments the system can be configured in a manner wherein the local non-transitory computer-readable media or the remote non-transitory computer readable media contain instructions for the authentication system to perform a plurality of tasks, including: generate a map containing a plurality of symbols provided at static positions on the map; present the map to a user on the display interface; request a username from the user utilizing the user input interface; request input from the user in the form of a string of alphanumeric characters from the user input interface, the string of alphanumeric characters representing a password, wherein each alphanumeric character in the string of alphanumeric characters is associated with one or more of the plurality of symbols on the map; associate the password with the username; and store the username and password as a means for authentication for future access to a system by the user.

In some embodiments the instructions can include instructions to also perform the following tasks: request input from the user regarding an associated alphanumeric character for each symbol provided on the map; and prepare a key illustrating each symbol and the input associated alphanumeric table.

In some embodiments the instructions can include instructions to also perform the following task: present the key and the map to the user upon subsequent system access attempts.

In some embodiments the instructions can include instructions to also perform the following task: present the key to the user upon receiving a password hint prompt from the user.

In some embodiments the instructions can include instructions to also perform the following task: request input from the user regarding an associated alphanumeric character for each symbol provided on the map.

In some embodiments the instructions can include instructions to also perform the following task: present a target map and one or more distractor maps to the user upon subsequent system access attempts.

In some embodiments the instructions can include instructions to also perform the following task: automatically generate a key with an associated alphanumeric character for each symbol provided on the map.

In some embodiments the map can represent a fictional topography, wherein the fictional topography can be generated by the authentication system. However, the map can also represent a real place, or be generated by the user themselves.

Also contemplated herein is an authentication method, wherein the method can include various steps, including: generating a map, the map containing a plurality of symbols provided at static positions on the map; presenting the map to a user; requesting input from the user regarding a username and a string of alphanumeric characters, the string of alphanumeric characters representing a password, wherein each alphanumeric character in the string of alphanumeric characters is associated with a plurality of symbols on the map; storing the username and password as a means for authentication for future access to a system by the user; and presenting the map to the user upon subsequent system access attempts.

In some embodiments, the method can also include the steps of: requesting input from the user regarding an associated alphanumeric character for each symbol provided on the map; and preparing a key illustrating each symbol and the input associated alphanumeric table.

In some alternative embodiments, the method can include: presenting the key to the user upon receiving a password hint prompt from the user.

In some alternative embodiments, the method can include: presenting a target map and one or more distractor maps to the user upon subsequent system access attempts.

In some alternative embodiments, the method can include: generating a key with an associated alphanumeric character for each symbol provided on the map.

In some alternative embodiments, the method can include: presenting the key to the user upon receiving a password hint prompt from the user.

In some alternative embodiments, the method can include: withholding the presentation of the map to the user after a threshold number of successful subsequent logins are achieved.

An additional authentication method is also contemplated herein, which can include the steps of: generating a map, the map containing a plurality of symbols provided at static positions on the map; presenting the map to a user; requesting input from the user regarding a username and a string of alphanumeric characters, the string of alphanumeric characters representing a password, wherein each alphanumeric character in the string of alphanumeric characters is associated with a plurality of symbols on the map; storing the username and password as a means for authentication for future access to a system by the user; presenting the map to the user upon subsequent system access attempts; and preparing a key containing an associated alphanumeric character for each symbol provided on the map, the key illustrating each symbol and the input associated alphanumeric table.

Such a method can also include the step of presenting the key to the user upon subsequent system access attempts.

These aspects of the invention are not meant to be exclusive and other features, aspects, and advantages of the present invention will be readily apparent to those of ordinary skill in the art when read in conjunction with the following description, appended claims, and accompanying drawings. Further, it will be appreciated that any of the various features, structures, steps, or other aspects discussed herein are for purposes of illustration only, any of which can be applied in any combination with any such features as discussed in alternative embodiments, as appropriate.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention, wherein:

FIG. 1 illustrates a schematic of an exemplary system which can be utilized to implement various steps and methods in accordance with various aspects of the present invention;

FIG. 2 illustrates an exemplary login screen being illustrative of various steps and methods in accordance with various aspects of the present invention;

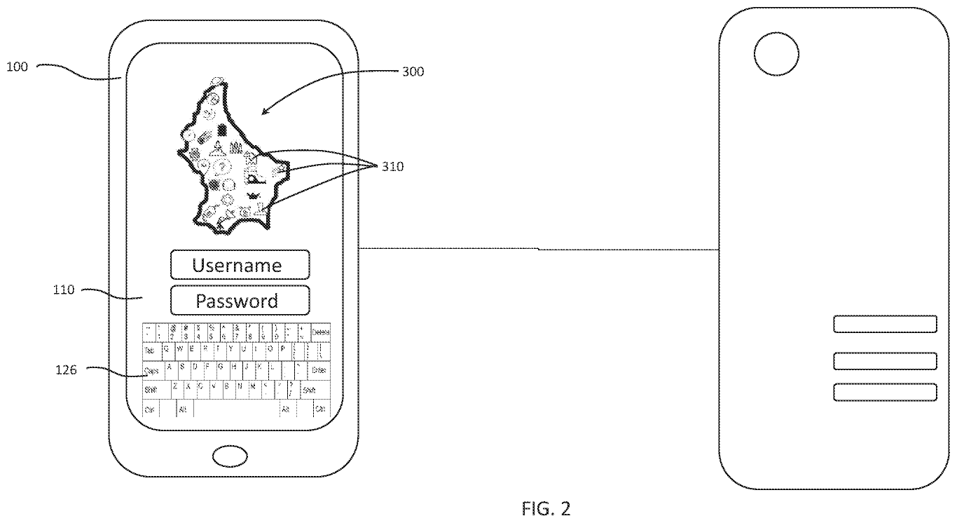

FIG. 3 illustrates an exemplary graphical aide for use in selecting and remembering an associated numerical password in the system of FIG. 1 being illustrative of various steps and methods in accordance with various aspects of the present invention;

FIG. 4 illustrates an exemplary key associated with an exemplary graphical aide for use in selecting and remembering an associated numerical password in the system of FIG. 1 being illustrative of various steps and methods in accordance with various aspects of the present invention;

FIG. 5 illustrates additional exemplary graphical aides having a distractor and a target aide which can be utilized in selecting and remembering an associated numerical password in the system of FIG. 1 being illustrative of various steps and methods in accordance with various aspects of the present invention; and

FIG. 6 illustrates an additional exemplary login screen being illustrative of various potential steps, features, and methods in accordance with various aspects of the present invention.

### DETAILED DESCRIPTION OF THE INVENTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or other structure is referred to as being “on” or extending “onto” another element, it can be directly on or extend directly onto the other element or intervening elements may also be present. In contrast, when an element is referred to as being “directly on” or extending “directly onto” another element, there are no intervening elements present.

Likewise, it will be understood that when an element such as a layer, region, or material is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “vertical” or “horizontal” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

It will be appreciated by those having skill in the area of password generation and system authentication, that increasing security typically increases an associated time for authentication, and that increasing security while simultaneously reducing authentication input times are a continuing endeavor.

By way of example, increasing the complexity of a given alphanumeric password may result in an increase in security, however, it also renders such passwords difficult to remember, increasing time it takes for a user to enter them, and taking them too far with regard to complexity merely causes users to subvert the system by using non-secure means of remembering the passwords, such as writing them down or otherwise storing the password in an insecure manner at an access point.

As such, a system which aids in remembering such passwords while simultaneously maintaining complexity allowing for increased security without substantially increasing login times will clearly offer benefits in this field.

In order to achieve this result, an authentication system is contemplated herein which combines graphical and alphanumeric authentication. The system contemplated herein utilizes a hybrid authentication approach which utilizes a conventional strong alphanumeric password which would typically be difficult to remember wherein the alphanumeric password is generated utilizing a complex graphical scheme.

The authentication system as contemplated herein can be utilized to present a map and provide a plurality of icons thereon. The map theme can include of a unique set of icons that pertained to a plurality of potential distractors and potential target icons. The user can then select a plurality of icons to serve as the targets, in a particular order, which can then have an associated character or characters associated therewith, which can then form a basis of a strong password.

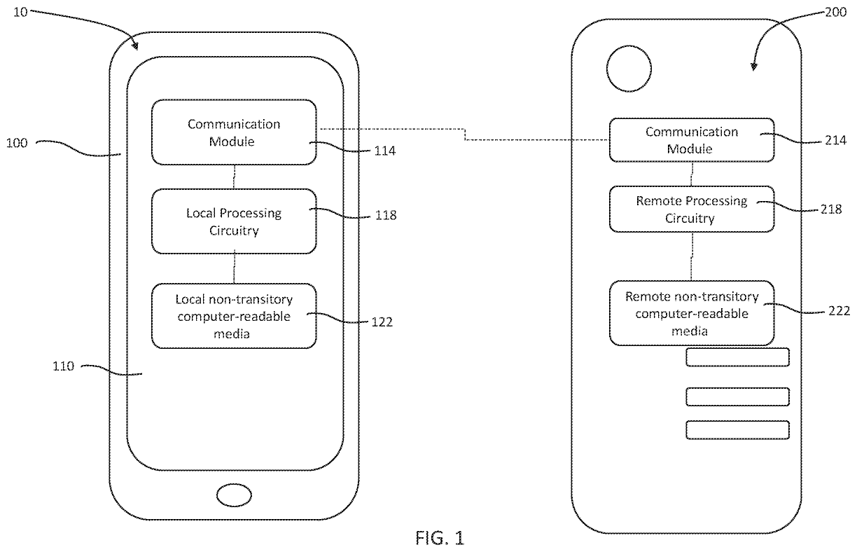

FIG. 1 illustrates an exemplary computational framework 10 which can employ the authentication system or associated methods as contemplated herein. As such the system can include a terminal 100 through which a user may interact with the system. It will be appreciated that the exemplary computer framework as illustrated can then utilize the authentication system and methods as contemplated herein. In some exemplary embodiments, the terminal 100 can include a display interface 110 for displaying graphics, prompts, input boxes, or virtually any other item for presenting information to the user, the display interface 110 can be provided as an LCD or LED display or any other display as will be recognized by those having skill in the art. The terminal 100 can then also include a user input interface 126, which can be a touchscreen, a separate keyboard, mouse, or any other contemplated interface for receiving user input, namely their credentials such as username and password. Such an input interface may also then be subsequently utilized for interacting with the system upon authentication. In order to recognize the inputs and implement various tasks by the system and terminal 100, the terminal can also be provided with local processing circuitry 118. In such cases, in order to instruct the processing circuitry 118, the terminal 100 can also include local non-transitory computer-readable media 122 which can include instructions for the local processing circuitry to perform various tasks.

In some embodiments the terminal can include a local communication module 114 which can be utilized to access a remote server 200. For example, wherein some tasks are completed, or information is stored remotely, such as for network access authorization, wherein a user may be working at various terminals, where the terminal is a mobile device, or wherein multiple users may require authentication on a common network. In some cases, the system can include multiple terminals 100 on which a user can enter authentication credentials and thus gain access to a given network or system.

In some embodiments, the remote server 200 can then include remote processing circuitry 218, remote non-transitory computer-readable media 222, and an associated communication module 214 for receiving information from the terminal and verifying user credentials at such a terminal.

As contemplated herein, in some embodiments, for either local authentication of for remote authentication, it will be appreciated that either the local non-transitory computer-readable media or the remote non-transitory computer readable media contain instructions for the authentication system to perform the various tasks required to authenticate the user's credentials utilizing various methods in accordance with the present invention.

As contemplated herein, the user can be presented with a map 300 having a plurality of icons 310 provided thereon. In some embodiments the map can be retrieved from a map database as contained on a non-transitory computer-readable medium or randomly generated. In some instances, the map 300 can be a representation of a real place or it can be a representation of a computer-generated fictional map with a plurality of icons placed in a random manner thereon. Each of the icons can then be utilized as a target or distractors with each icon having one or more associated symbols for use in creation and recollection of a password.

In order for a user to create their own password, upon account creation the user can be prompted to select a username, then upon username selection the user can be presented with the map and the icons thereon. The user can then mentally select a route or path on the map extending through a plurality of the icons, wherein their route through the icons can be utilized with each associated symbol so as to generate a custom password which can then be associated with their username for future authentication for access to the system protected by the authentication system.

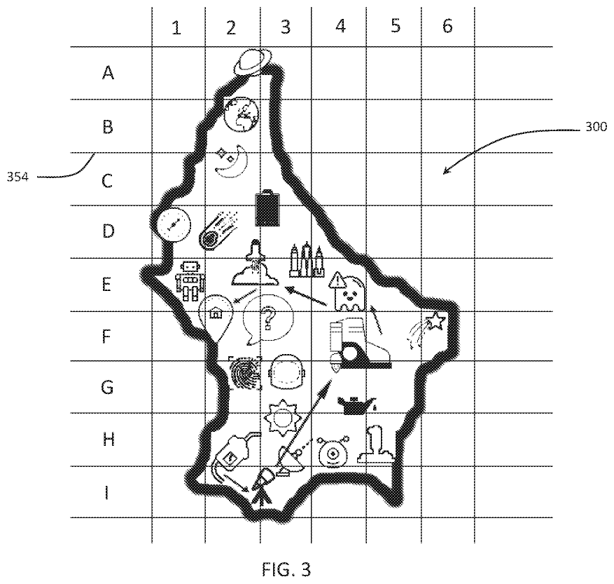

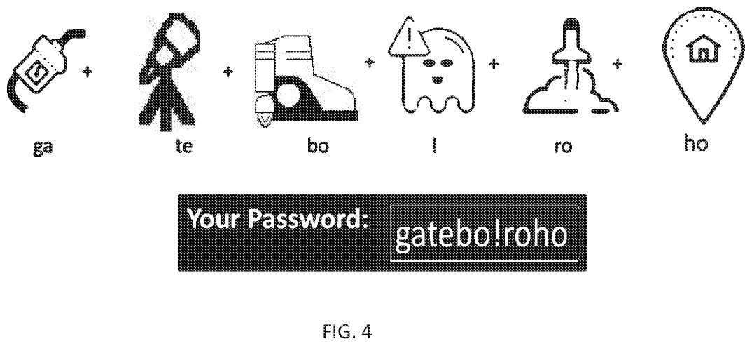

This password selection process is illustrated in FIGS. 3-4, wherein the user password is selected by the route illustrated in FIG. 3, and wherein the sequential icon selection relates to the password, gatebo!roho, gas (ga), telescope (te), boot (bo), ghost with symbol ! (!), rocket (ro), symbol with house (ho) which is a strong and difficult password to decipher through machine learning as well as over the shoulder attacks. However, such a password can be more easily remembered by a user in future authentications by presenting the map having the uniquely placed icons upon future authentication attempts. This method is advantageous because the user does not manually select the icons, nor manually select the route, which in previous systems has resulted in increased vulnerability to over-the-shoulder attacks. However, because a route can be more easily remembered than the individual complex characters forming the password, users can remember such a complex password without unduly increasing login time. The route or pathway between the series of various selected target icons representing the order in which they form the password can then be disguised among a plurality of distractor icons.

It will then be understood that for each instance the system can generate a map containing a plurality of symbols provided at static positions on the map. However, in some alternative instances, the user can be presented with a pre-generated map, and the icons can be pre-populated thereon. However, in some instances the user can be requested to draw a custom map, be presented with a plurality of maps from which a target map can be selected. Further, the system can pre-populate the icons on the map, or have the user select their own icons, which can be randomly placed, or custom placed on the map. For example, the user may be presented a list of icons and be allowed to drag and drop a custom plurality of icons onto the map from a list of pre-populated icons.

In any case, the system can be utilized to request a username from the user utilizing the user input interface and request input from the user in the form of a string of alphanumeric characters to act as a password, wherein each alphanumeric character in the string of alphanumeric characters is associated with one or more of the plurality of symbols on the map.

The system can then associate the password with the username and store the username and password as a means for authentication for future access to a system or network protected by the system for use by the user.

In some instances, the system can generate and present a key showing an associated character for each icon provided on the map. In such cases the system can be utilized to prepare such a key and automatically select or have pre-selected characters associated with each icon. However, in some instances the user can be prompted to provide an associated character or plurality of characters to associate with each icon. In which case, the system can then save the user inputs and associations for each icon.

Upon future or subsequent system access attempts the key can then be presented to the user. In some instances, the key can be saved and presented to the user on all login attempts, however, in some alternative instances the key can be hidden and serve as a password hint reminder only upon user request.

In some instances, the key can be hidden except upon correctly responding to a security question, etc. In some additional instances the key can be presented to the user only upon an initial threshold number of logins. For example, the key can be presented to the user for the first 100 successful login attempts, but hidden after the user has properly learned their password, thus serving as a learning aid, but then be hidden upon the user memorizing their password, and thus increasing security of the map and icon path thereon.

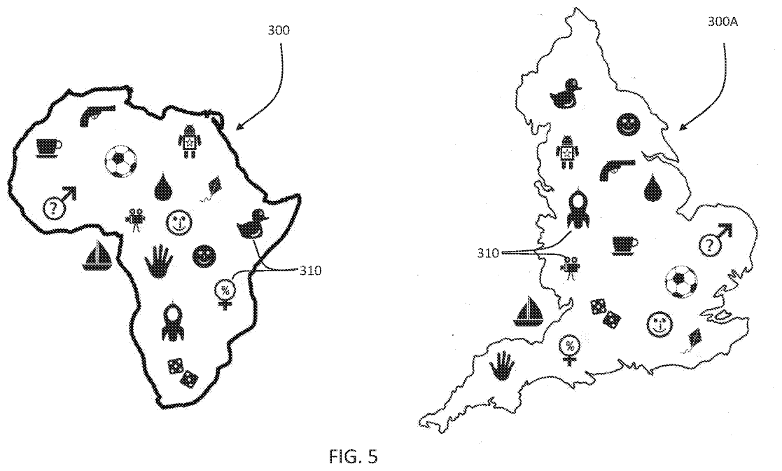

In some embodiments, the system can be utilized to present a plurality of maps to the user with common icons provided thereon as illustrated in FIG. 5. In such cases one map can represent a target map and another map can then represent a distractor map 350A or maps such that the particular target map 350 and associated correct icon path can be further disguised and thus protect against over the shoulder attacks. It will then be appreciated that presentation of multiple maps will typically be reserved for situations in which the terminal includes a larger display, such as when the terminal is embodied in a tablet, laptop, or desktop, but less likely to be used in situations in which the terminal is embodied in the form of a handheld device such as a smartphone.

It will then be appreciated that any of the methods or steps discussed herein can be performed locally on a terminal, for example logging into a smartphone, or can be used in combination with a terminal and a server on a network where some information can be saved locally or remotely as appropriate. For example, for network access, the user password, map, icons, and associated characters can each be saved at a network location, wherein user input is transmitted securely and verified upon submission. In contrast, if only terminal or local login is required for some applications, the passwords, maps, icons, and associated characters can be stored locally without necessitating communication with a remote server, etc.

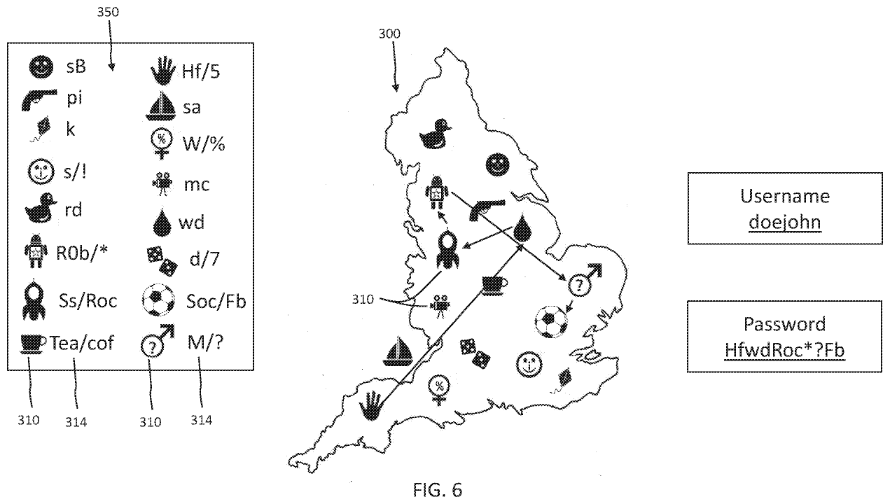

As discussed briefly above, and as illustrated in FIG. 6, the system can generate and display a key 350 with each of the icons 310 with their associated characters 314 being provided thereon, for example, in a table. However, additional complexity can be provided with regard to associations of characters to each icon. For example, some icons may have various embedded symbols provided in their respective images, such as a hidden star, exclamation point, etc. Further, each symbol may have multiple potential interpretations regarding what that icon might represent or what characters might represent it. In such cases the key 350 can be generated wherein each icon has a plurality of potential associations, wherein the user can select one, multiple, or all of the representations as part of their password. In this manner, the key 350 itself can have a target associated character or characters and one or more distractor characters, thus adding to the security of the key 350 even when displayed.

In short, the authentication system as contemplated herein thus utilizes a graphical scheme which displays a map populated with icons wherein the icons and the map provides the user with a rich field of potential target icons and distractor icons which can provide a user with a plurality of potential associated alphanumeric character selections for generating, and later remembering, their strong password.

In yet additional embodiments, a grid 354 can be placed on each map wherein each grid square was assigned a number, or wherein each column and row can have an associated number or letter, which can also be used as part of the password selection process.

In some embodiments, the icons can be placed using the grid and a random number generator.

It will be appreciated that users should be encouraged not to point to icons associated with their password on the terminal screen.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion within a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, or the device including the element.

The foregoing has provided a detailed description of various embodiments of a multi-modal multi-media filtration system and various principles associated therewith. Specific examples are used herein to describe the principles and implementations of some embodiments. The description is only used to help convey understanding of the possible methods and concepts. Meanwhile, those of ordinary skill in the art may change the specific manners of implementation and application thereof without departing from the spirit of the invention. The contents of this specification therefore should not be construed as limiting the disclosure.

In the descriptions, with respect to unit(s), device(s), component(s), etc., in some occurrences singular forms are used, and in some other occurrences plural forms are used in the descriptions of various embodiments. It should be noted; however, the single or plural forms are not limiting but rather are for illustrative purposes. Unless it is expressly stated that a single unit, device, or component etc. is employed, or it is expressly stated that a plurality of units, devices or components, etc. are employed, the unit(s), device(s), component(s), etc. can be singular, or plural.

Based on various embodiments of the present disclosure, the disclosed apparatuses, devices, and methods may be implemented in other manners. For example, the abovementioned devices can employ various methods of use or implementation as disclosed herein.

Dividing the device into different “regions,” “units,” or “layers,” etc. merely reflect various logical functions according to some embodiments, and actual implementations can have other divisions of “regions,” “units,” or “layers,” etc. realizing similar functions as described above, or without divisions. For example, multiple regions, units, or layers, etc. may be combined or can be integrated into another system. In addition, some features can be omitted, and some steps in the methods can be skipped.

Those of ordinary skill in the art will appreciate that the units, regions, or layers, etc. in the devices provided by various embodiments described above can be provided in the one or more devices described above. They can also be located in one or multiple devices that is (are) different from the example embodiments described above or illustrated in the accompanying drawings. For example, the units, regions, or layers, etc. in various embodiments described above can be integrated into one module or divided into several sub-modules.

The order of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to the disclosed aspects of the exemplary embodiments can be made in addition to those described above by a person of ordinary skill in the art having the benefit of the present disclosure without departing from the spirit and scope of the invention contemplated by this disclosure and as defined in the following claims. As such, the scope of this disclosure is to be accorded the broadest reasonable interpretation so as to encompass such modifications and equivalent structures.

We claim:

1. An authentication system comprising:
a terminal, the terminal comprising:
a display interface;
a user input interface;
local processing circuitry;
a local non-transitory computer-readable media; and
a local communication module;
a remote server, the remote server comprising:
remote processing circuitry;
remote non-transitory computer-readable media;
a communication module for receiving information from the terminal;
wherein the local non-transitory computer-readable media or the remote non-transitory computer readable media contain instructions for the authentication system to perform the following tasks:
generate a map containing a plurality of symbols provided at static positions on the map;
present the map to a user on the display interface;
request a username from the user utilizing the user input interface;
request input from the user in the form of a string of alphanumeric characters from the user input interface, the string of alphanumeric characters representing a password, wherein each alphanumeric character in the string of alphanumeric characters is associated with one or more of the plurality of symbols on the map;
associate the password with the username; and
store the username and password as a means for authentication for future access to a system by the user.

2. The authentication system of claim 1, wherein the local non-transitory computer-readable media or the remote non-transitory computer readable media contain instructions for the authentication system to perform the following tasks:
request input from the user regarding an associated alphanumeric character for each symbol provided on the map; and
prepare a key illustrating each symbol and the input associated alphanumeric table.

3. The authentication system of claim 2, wherein the local non-transitory computer-readable media or the remote non-transitory computer readable media contain instructions for the authentication system to perform the following task:
present the key and the map to the user upon subsequent system access attempts.

4. The authentication system of claim 2, wherein the local non-transitory computer-readable media or the remote non-transitory computer readable media contain instructions for the authentication system to perform the following task:
present the map to the user upon subsequent system access attempts.

5. The authentication system of claim 4, wherein the local non-transitory computer-readable media or the remote non-transitory computer readable media contain instructions for the authentication system to perform the following task:
present the key to the user upon receiving a password hint prompt from the user.

6. The authentication system of claim 1, wherein the local non-transitory computer-readable media or the remote non-transitory computer readable media contain instructions for the authentication system to perform the following tasks:
request input from the user regarding an associated alphanumeric character for each symbol provided on the map.

7. The authentication system of claim 1, wherein the local non-transitory computer-readable media or the remote non-transitory computer readable media contain instructions for the authentication system to perform the following task:
present a target map and one or more distractor maps to the user upon subsequent system access attempts.

8. The authentication system of claim 1, wherein the local non-transitory computer-readable media or the remote non-transitory computer readable media contain instructions for the authentication system to perform the following tasks:
generate a key with an associated alphanumeric character for each symbol provided on the map.

9. The authentication system of claim 8, wherein the local non-transitory computer-readable media or the remote non-transitory computer readable media contain instructions for the authentication system to perform the following task:
present the map to the user upon subsequent system access attempts.

10. The authentication system of claim 8, wherein the local non-transitory computer-readable media or the remote non-transitory computer readable media contain instructions for the authentication system to perform the following task:
present the key to the user upon receiving a password hint prompt from the user.

11. The authentication system of claim 1, wherein the map represents a fictional topography, the fictional topography being generated by the authentication system.

12. An authentication method, the method comprising:
generating a map, the map containing a plurality of symbols provided at static positions on the map;
presenting the map to a user;
requesting input from the user regarding a username and a string of alphanumeric characters, the string of alphanumeric characters representing a password, wherein each alphanumeric character in the string of alphanumeric characters is associated with a plurality of symbols on the map;
storing the username and password as a means for authentication for future access to a system by the user; and
presenting the map to the user upon subsequent system access attempts.

13. The authentication method of claim 12, further comprising:
requesting input from the user regarding an associated alphanumeric character for each symbol provided on the map; and
preparing a key illustrating each symbol and the input associated alphanumeric table.

14. The authentication method of claim 13, further comprising:
presenting the key to the user upon receiving a password hint prompt from the user.

15. The authentication method of claim 12, further comprising:
presenting a target map and one or more distractor maps to the user upon subsequent system access attempts.

16. The authentication method of claim 12, further comprising:
generating a key with an associated alphanumeric character for each symbol provided on the map.

17. The authentication method of claim 16, further comprising:
presenting the key to the user upon receiving a password hint prompt from the user.

18. The authentication method of claim 11, further comprising:
withholding the presentation of the map to the user after a threshold number of successful subsequent logins are achieved.

19. An authentication method, the method comprising:
presenting to a map to a user, the map containing a plurality of symbols provided at static positions on the map;
requesting input from the user regarding a username and a string of alphanumeric characters, the string of alphanumeric characters representing a password, wherein each alphanumeric character in the string of alphanumeric characters is associated with a plurality of symbols on the map;
storing the username and password as a means for authentication for future access to a system by the user; and
presenting the map to the user upon subsequent system access attempts.

20. The authentication method of claim 19, further comprising:
preparing a key containing an associated alphanumeric character for each symbol provided on the map, the key illustrating each symbol and the input associated alphanumeric table; and
presenting the key to the user upon subsequent system access attempts.
